(19) United States
(12) Patent Application Publication
(10) Pub. No.: US 2014/0263058 A1
(43) Pub. Date: Sep. 18, 2014

(54) METHODS OF FILTRATION AND CHEMICAL TREATMENT OF WASTE WATER

(71) Applicant: Richard H. Fagher, Bath, OH (US)

(72) Inventor: Richard H. Fagher, Bath, OH (US)

(21) Appl. No.: 14/201,270

(22) Filed: Mar. 7, 2014

Related U.S. Application Data
(60) Provisional application No. 61/777,983, filed on Mar. 12, 2013.

(51) Int. Cl. C02F 9/00; C02F 1/50; C02F 1/44; C02F 1/52; C02F 1/56

(52) U.S. Cl. CPC C02F 9/00; C02F 1/5245; C02F 1/56; C02F 1/441; C02F 1/50
USPC 210/639; 210/724; 210/725; 210/199; 210/710

(57) ABSTRACT

A method and system for treating waste water from hydraulic fracturing is disclosed. The treatment includes removing the sand, suspending the inorganic metals and impurities, using flocculation to engulf the impurities, and separating the impurities from the water, resulting in pure water that can be reused in the process.

### CROSS-REFERENCE TO RELATED APPLICATION

This application claims priority from U.S. Provisional Application Ser. No. 61/777,983 which was filed on Mar. 12, 2013. The entire content of that application is incorporated hereinto by reference.

### BACKGROUND

The present disclosure relates to methods and devices that are useful for filtration and chemical treatment of waste water. It finds particular application in hydraulic fracturing processes, and will be described with particular reference thereto. However, it is to be appreciated that the present disclosure is also amenable to other like applications.

Generally, hydraulic fracturing waste water is composed of 85% water, 10% sand, and 5% chemicals. The 5% of chemicals in the hydraulic fracturing waste water can contain a wide range of possible different compounds, such as inorganic salts and flocculants, organic chemicals, and biocides.

There are currently several methods available for the treatment of waste water. Examples are removal of solids by gravitation, coagulation (which depends on the electric charge among particles), and flocculation (which does not depend on the electric charge among particles).

### BRIEF DESCRIPTION

The present disclosure provides method for filtering and treating waste water to obtain pure water that can be reused.

These and other non-limiting characteristics of the disclosure are more particularly disclosed below

### BRIEF DESCRIPTION OF THE DRAWINGS

The following is a brief description of the drawing, which is presented for the purposes of illustrating the disclosure set forth herein and not for the purposes of limiting the same

FIG. 1 is an illustration of an exemplary filtration and treatment method and system used for the treatment of waste water.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the term “from about 2 to about 4” also discloses the range “from 2 to 4.”

Disclosed in various embodiments are devices and methods for filtering and chemically treating waste water using flocculation. This can be applied to treating waste water that is created during, for example, a hydraulic fracturing process. More details of the methods and systems follow with reference to FIG. 1. The methods can be generally divided into three (3) phases. The system includes a water flowpath and multiple solids flowpaths.

Initially, waste water from waste water source 101 is piped through waste water basin inlet 111 into waste water basin 110. Water source 101 can be a well from a hydraulic fracturing process. The waste water from the hydraulic fracturing process is generally a combination of sand, inorganic salts and flocculants, organic chemical and biocides. Generally, hydraulic fracturing water is composed of 85% water, 10% sand, and 5% chemicals. The chemicals in the hydraulic fracturing water can contain a wide range of possible different compounds. The volume of the waste water basin 110 can be altered as desired.

Biocides and bactericides may optionally be added to waste water basin 110 to treat the waste water. The biocides and bactericides may be used to kill microorganisms including, but not limited to, slime forming bacteria and algae, as well as sulfate reducing bacteria. They can also prevent algae growth in the waste water basin 110. The basin can be used to provide storage, generate enough head to run the system, etc.

Phase 1 encompasses the removal of solids from the waste water. The waste water exits waste water basin 110 through outlet 112 and enters the centrifuge 120 through inlet 121. Rinse water 125 is also pumped into centrifuge 120 through rinse inlet 123. The waste water and rinse water are centrifuged to ensure complete precipitation and removal of the solids in the waste water. These solids include sand. The solids removed in centrifuge 120 exit through centrifuge solids outlet 124, and the waste water exits through water outlet 122. The solids may then be recycled back to the well for reuse in the fracking process.

Optionally, a separation tank 130 can be included in the system wherein the waste water and any remaining solids may be decanted to remove the final solids. The separation tank receives water from the centrifuge through inlet 131, and water exits through outlet 132.

Phase 2 encompasses the chemical treatment of the waste water. The waste water can be provided from centrifuge 120 through centrifuge water outlet 122, or from the separation tank 130 through separation tank outlet 132. The waste water enters the acidification tank 140 through inlet 141. In acidification tank 140, inorganic metals and impurities are dissolved. Exemplary impurities include various minerals.

An acid source 145 provides acid that is used to lower the pH of the waste water in the acidification tank through inlet 143. A mineral acid, like sulfuric acid (H₂SO₄) or hydrochloric acid (HCl), can be used. A pH of about 1 to about 2 is needed to ensure all impurities and inorganic metals are dissolved.

The waste water then leaves acidification tank 140 through outlet 142 and enters chemical suspension tank 150 through inlet 151. In the chemical suspension tank a base is added to the waste water from base source 155 through inlet 153. The base can be sodium hydroxide (NaOH), potassium hydroxide (KOH), or calcium hydroxide (Ca(OH)₂). The base is added in an amount sufficient to raise the pH of the waste water up to about 14. This causes the inorganic metals and impurities to be suspended.

After the inorganic metals and impurities are suspended, the waste water leaves chemical suspension tank 150 through outlet 152 and enters polymer treatment tank 160 through inlet 161. In polymer treatment tank 160 the waste water is treated with a flocculant from flocculant source 165 entering through inlet 163.

Different types of flocculants, inorganic and organic, can be utilized in the filtration and chemical treatment of waste water. Inorganic flocculants include salts of multivalent metals, such as aluminum and iron. When salts of multivalent metals are used in filtration and treatment of waste water, they are used at very high levels. This can lead to large sludge deposits, which can be affected by pH changes. Organic flocculants are typically polymeric in nature. When organic flocculants are used in the filtration and treatment of waste water, they are used at very low levels. The polymeric flocculants can be synthetic or natural water-miscible polymers. The polymer used may be natural or synthetic. The polymer may be cationic, nonionic, anionic, or amphoteric.

Desirably, a natural polymer is used as the flocculant to remove the suspended impurities and inorganic metals. Preferably the polymer will be natural and biodegradable, not synthetic. Examples of a natural biodegradable polymer include polysaccharides, which are starchy in nature. When the waste water is treated with the polymers, the polymers will establish flocculants. The flocculants will engulf or capture the impurities and the inorganic metals, making their separation possible.

Phase 3 encompasses the filtering the waste water. After the waste water is treated with a flocculant, it exits polymer treatment tank 160 through outlet 162. The waste water enters filtration system 170 through inlet 171. In filtration system 170, the waste water and the impurities are filtered to separate the pure water from sludge. The sludge contains all the organic and inorganic impurities. The sludge leaves filtration system 170 through solids outlet 174. The filtered water leaves filtration system 170 through outlet 172. Filtered water is thus obtained.

The sludge enters incinerator 180 through sludge inlet 181 and is incinerated. The incinerated sludge fumes may exit the incinerator throough outlet 182 be fed into a fume treatment or neutralization basin 185 through inlet 186 to prevent the fumes from going into the atmosphere. The neutralization basin 185 may contain a 20% potassium hydroxide solution that neutralizes pollutants in the fumes. The fumes then exit the basin.

Optionally, the filtered water can be filtered a second time in reverse osmosis filtration system 175 before being pumped into treated water basin 190 if high quality water is desired. The water enters the reverse osmosis system through inlet 176 and exits through outlet 177.

The filtered water will be pumped into treated water basin 190 through inlet 191 from filtration system 170, or from reverse osmosis filtration system 175 if included.

The filtered water in treated water basin 190 may optionally be recycled from treated water basin 190 through outlet 192. In a hydraulic filtration system, the filtered water can be recycled back to the well through outlet 192.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A method of filtering and treating waste water, comprising:
centrifuging the waste water to remove solids from the waste water;
acidifying the waste water to dissolve inorganic metals and impurities;
adding a base to the waste water to suspend inorganic metals and impurities;
adding a flocculant to the waste water to capture the suspended inorganic metals and impurities; and
filtering the waste water to remove sludge and obtain filtered water.

2. The method of claim 1, further comprising treating the waste water with biocides and bactericides prior to centrifuging.

3. The method of claim 1, wherein the solids removed from the waste water by centrifuging are recycled.

4. The method of claim 1, further comprising decanting the waste water after centrifuging the waste water.

5. The method of claim 1, wherein a mineral acid is used to acidify the waste water.

6. The method of claim 5, wherein the mineral acid is sulfuric acid or hydrochloric acid.

7. The method of claim 5, wherein the mineral acid is added to the waste water in an amount sufficient to lower the pH of the waste water to a pH of about 1 to about 2.

8. The method of claim 1, wherein the base is added to the waste water in an amount sufficient to raise the pH of the waste water to a pH of about 14.

9. The method of claim 8, wherein the base is sodium hydroxide, potassium hydroxide, or calcium hydroxide.

10. The method of claim 1, wherein the flocculant is a natural biodegradable polymer or a biodegradable modified polymer.

11. The method of claim 10, wherein the natural biodegradable polymer is a polysaccharide.

12. The method of claim 1, further comprising incinerating the sludge that is separated from the waste water.

13. The method of claim 13, further comprising treating the fumes formed from incinerating the sludge by passing the fumes through a potassium hydroxide solution.

14. The method of claim 1, further comprising filtering the filtered water a second time using reverse osmosis.

15. A system to filter and treat waste water, the system having a water flowpath comprising:
a waste water basin;
a centrifuge downstream of the waste water basin;
a separation tank downstream of the centrifuge;
an acidification tank downstream of the separation tank;
a chemical suspension tank downstream of the acidification tank;
a polymer treatment tank downstream of the chemical suspension tank;
a filtration system downstream of the polymer treatment tank; and
a treated water basin downstream of the filtration system.

16. The system of claim 15, further comprising an incinerator downstream of the filtration system, wherein the sludge is in a solids flowpath exiting the filtration system.

17. The system of claim 16, further comprising a neutralization basin downstream of the incinerator.

18. The system of claim 17, further comprising a reverse osmosis filtration system in the water flowpath downstream of the filtration system and upstream of the treated water basin.

19. The system of claim 15, further comprising an acid source feeding into the acidification tank.

20. The system of claim 15, further comprising a base source feeding into the chemical suspension tank.

21. The system of claim 15, further comprising a flocculant source feeding into the polymer treatment tank.

22. A method of filtering and treating waste water from a hydraulic fracturing process, comprising:
piping waste water from a well to a waste water basin;
centrifuging the waste water in a centrifuge to remove solids from the waste water;
recycling the solids removed from the waste water back to the well;
decanting the waste water in a separation tank;
acidifying the waste water in a acidification tank to dissolve minerals and inorganic metals;
adding a base to the waste water in a chemical suspension tank to suspend inorganic metals and impurities;
adding a flocculant to the waste water in a polymer treatment tank to capture suspended inorganic metals and impurities;
filtering the waste water through a filtration system to remove sludge and obtain filtered water;
incinerating the sludge in an incinerator;
treating the incinerated sludge fumes in a potassium hydroxide basin; and
pumping the filtered water into a treated water basin.

23. The method of claim 22, further comprising filtering the filtered water in a second reverse osmosis filtration system.
